(19) United States
(12) Patent Application Publication
(10) Pub. No.: US 2021/0047496 A1
(43) Pub. Date: Feb. 18, 2021

(54) Graphene-Based Liquid Crystal Dispersion Liquid, Liquid Crystal Composite Elastic Fiber and Method for Preparing Same

(71) Applicant: Korea Advanced Institute of Science and Technology, Daejeon (KR)

(72) Inventors: Sang Ouk Kim, Daejeon (KR); In Ho Kim, Daejeon (KR); Taeyeong Yun, Daejeon (KR); Hong Ju Jung, Daejeon (KR)

(21) Appl. No.: 16/476,344

(22) PCT Filed: Jan. 10, 2018
(86) PCT No.: PCT/KR2018/000499

§ 371 Date: Oct. 23, 2020

(30) Foreign Application Priority Data
Jan. 10, 2017 (KR) 10-2017-0003311

(51) Int. Cl. C08K 3/04; D01F 9/24; D01D 5/00; D01D 5/06

(52) U.S. Cl. CPC C08K 3/042; C08K 3/041; D01D 5/06; D01D 5/0007; D01F 9/24

(57) ABSTRACT

The present invention relates to a liquid crystal composite elastic fiber manufactured by means of spinning a graphene-based composition in which graphene-based materials are dispersed into a polymer solution including polymer having a polar group so that the polymer is intercalated in or chemically reacted with the graphene-based materials. The present invention also related to a method of manufacturing the same.

### TECHNICAL FIELD

The present invention relates to a graphene-based liquid crystal dispersion, a liquid crystal composite elastic fiber, and a method of manufacturing the same. Particularly, the present invention relates to a graphene-based liquid crystal dispersion obtained by dispersing or reacting a polymer having a polar functional group in or with a graphene-based material so that the polymer is intercalated in the graphene-based material, a liquid crystal composite elastic fiber, and a method of manufacturing the same.

### BACKGROUND ART

In general, an electrically conductive fiber (hereinafter, referred to as a conductive fiber) means a fibrous material which includes a material capable of conducting electricity through the fiber itself or the internal or external structure to allow a certain level of electricity to flow.

A method of manufacturing the conductive fiber may be largely classified into a method of using a conductive polymer and a method of combining a conductive material, and up to date, the fibers manufactured by the former technology exhibit good conductivity above a semiconductor level, but it is difficult to use the fiber for a general textile product due to the significantly reduced flexibility thereof. In addition, a fiber manufactured with a conductive polymer has a low conductivity to be used as a sensor or an electric wire.

In the latter case, the method may be more specifically classified into a method of incorporating a conductive additive material into a fiber to manufacture a fiber and a method of utilizing a plating technique to coat a general fiber. A conductive composite fiber manufactured by incorporation with a polymeric fiber has excellent durability and allows realization of various levels of physical properties and conductivities depending on the conductive additive material and the polymeric fiber, but there are disadvantages in that it is difficult to achieve a conductivity of 10² S/cm or more which is a conductor-level conductivity, and physical properties such as strength and elongation are deteriorated due to an increased content of the additive. However, the manufacture of a conductive fiber by post-treatment coating is variously attempted due to the not-high technical difficulty thereof, but has problems of decreased fiber tactility and decreased durability due to the coating.

In addition, a method of including graphene oxide in the conductive additive material to manufacture a conductive fiber has a technical limitation to date of exhibiting a conductivity in the level of 10° S/cm (single digit) which is a common degree of semiconductor, and it is currently very difficult to raise the content of the conductive additive material for expressing a higher conductivity, since decreased dispersibility due to high melt viscosity and a change in characteristics of the additive material due to high temperature and shear force are inevitable. In addition, when graphene oxide is dispersed in a conductive solvent and added up to 1% by weight to prepare a solution for fiber spinning, aggregation occurs and gelation is caused, and when a conductive fiber is manufactured, process efficiency is low and inherent physical properties are not implemented due to a low concentration, and thus, commercialization is delayed.

Accordingly, in order to utilize graphene-based materials such as graphene oxide as a conductive fiber, various studies for improving dispersibility and compatibility of the graphene-based materials such as graphene oxide are currently needed.

### DISCLOSURE

### Technical Problem

In order to solve the above problems, an object of the present invention is to provide a graphene-based liquid crystal dispersion, in which a polymer in a polymer solution including a polymer having a polar group is intercalated in or chemically reacted to be dispersed in a graphene-based material, so that the dispersion exhibits a liquid crystal phase, and a spinning solution for manufacturing a fiber including the graphene-based liquid crystal dispersion.

Another object of the present invention is to provide a graphene-based liquid crystal dispersion, in which a graphene-based material in a graphene-based composition is intercalated in or chemically reacted to be dispersed in a polymer having a polar group, so that the graphene-based material is included at a high concentration in a polymer solution while the dispersion has a low viscosity.

Another object of the present invention is to provide a liquid crystal composite elastic fiber manufactured by spinning a graphene-based composition including a polymer having a polar group and a graphene-based material and a method of manufacturing the same.

Another object of the present invention is to provide a liquid crystal composite elastic fiber, in which a polymer in a polymer solution including a polymer having a polar group is intercalated in or chemically reacted to be dispersed in a graphene-based material, thereby deriving a hydrogen bond or a covalent bond between the polymer and the graphene-based material so that phase separation does not occur, and a method of manufacturing the liquid crystal composite elastic fiber.

Another object of the present invention is to provide a liquid crystal composite elastic fiber, in which the graphene-based liquid crystal dispersion is spun in a state of maintaining a liquid crystal phase so that the fiber has excellent orientation in a fiber axial direction, and has excellent modulus of elasticity, high thermal conductivity, and electrical conductivity in a fiber axial direction even with a small amount of a graphene-based material, and a method of manufacturing the liquid crystal composite elastic fiber.

Still another object of the present invention is to provide a liquid crystal composite elastic fiber which has better electrical conductivity and elasticity when the graphene-based composition is composited with a carbon nanotube and used, and a method of manufacturing the liquid crystal composite elastic fiber.

### Technical Solution

In one general aspect, a method of manufacturing a liquid crystal composite elastic fiber includes:

a) dispersing or chemically reacting a graphene-based material in or with a polymer solution including a polymer having a polar group to prepare a graphene-based composition in which the polymer having a polar group is intercalated in the graphene-based material; and

b) spinning the graphene-based composition to obtain the liquid crystal composite elastic fiber.

The graphene-based composition may have liquid crystallinity.

The graphene-based composition may further include a carbon nanotube.

A weight ratio of the graphene-based material and the carbon nanotube may be 1:0.1 to 1:1.

0 0.8 to 10% by weight of the graphene-based material may be included, based on the total weight of the graphene-based composition.

The polymer solution may include 1 to 40% by weight of the polymer having a polar group, based on the total weight of the polymer solution.

The spinning may be wet spinning or electrospinning.

The polymer having a polar group may be any one or two or more polymers selected from the group consisting of polyalkylene glycol-based polymers, polyurethane-based polymers, and polyvinyl alcohol-based polymers.

A step of forming a covalent bond of the polyurethane-based polymer including a reactive functional group in step a) with the graphene-based material may be further included.

The liquid crystal composite elastic fiber according to the present invention may be manufactured by the above-described manufacturing method.

The liquid crystal composite elastic fiber according to the present invention may be a fiber in which a polymer having a polar group is inserted between the graphene-based material layers so that the polymer is hydrogen-bonded or covalently bonded to the graphene-based material.

The graphene-based material may further include a carbon nanotube and composited therewith.

The graphene-based material and the carbon nanotube may be composited at a weight ratio of 1:0.1 to 1:1.

The graphene-based material and the polymer having a polar group may be bonded at a weight ratio of 1:0.1 to 1:1,000.

In the graphene-based liquid crystal dispersion according to the present invention, the graphene-based material and the polymer having a polar group are hydrogen-bonded or covalently bonded to each other and intercalated, and the graphene-based liquid crystal dispersion may have a viscosity satisfying the following Equation 1:

$$0.05 ≺ \frac{{η}_{2}}{{η}_{1}} ≺ 0.7 \qquad [ Equation 1 ]$$

wherein η₁ is a viscosity of a dispersion in which only the graphene-based material and the solvent are mixed and dispersed, and η₂ is a viscosity of a dispersion in which the graphene-based material and the polymer solution are mixed and dispersed.

### Advantageous Effects

When a fiber was manufactured with a graphene-based composition which exhibits a liquid crystal phase and has a decreased viscosity to include the graphene-based material at a high temperature, by dispersing a polymer in a polymer solution including a polymer having a polar group according to the present invention in a graphene-based material so that the polymer is intercalated in the graphene-based material, the fiber has excellent conductivity.

In addition, the polymer in the polymer solution including the polymer having a polar group is dispersed in or chemically reacted with the graphene-based material so that the polymer is intercalated in the graphene-based material, whereby a hydrogen bond or a covalent bond between the polymer and the graphene-based material is derived and phase separation does not occur, and thus, when a fiber manufactured therefrom, the fiber has excellent elasticity and conductivity.

In addition, when the graphene-based material is composited with a carbon nanotube and used, the fiber may have better electrical conductivity and elasticity.

### DESCRIPTION OF DRAWINGS

FIG. 1 is a photograph of a scanning electron microscope (SEM) observing an electrospun fiber according to an exemplary embodiment of the present invention.

FIG. 2 is a schematic diagram of a graphene-based composition in which a graphene-based material is dispersed in a polymer solution including a polymer having a polar group according to an exemplary embodiment of the present invention.

FIG. 3 is a photograph of a polarizing microscope observing liquid crystal phase behavior of a graphene-based composition according to an exemplary embodiment of the present invention.

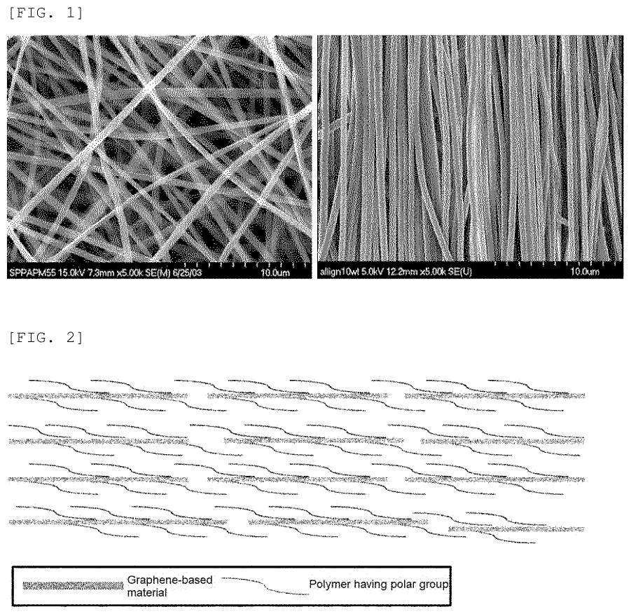

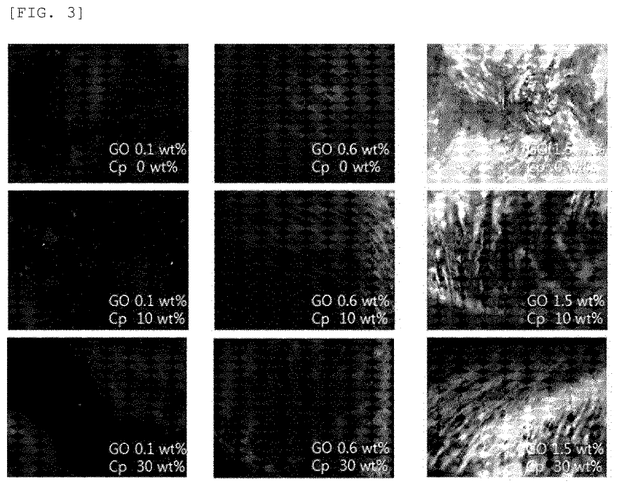

### BEST MODE

Hereinafter, a graphene-based liquid crystal dispersion, a liquid crystal composite elastic fiber, and a method of manufacturing the same according to the present invention will be described in more detail by the following exemplary embodiments. However, the following exemplary embodiments are only a reference for describing the present invention in detail, and the present invention is not limited thereto, and may be implemented in various forms.

In addition, unless otherwise defined, all technical terms and scientific terms have the same meanings as those commonly understood by one of those skilled in the art to which the present invention pertains. The terms used herein is only for effectively describing a certain exemplary embodiment, and not intended to limit the present invention.

In the present specification, “intercalation” means that molecules, atoms, or ions are inserted between layers of a material having a layered structure, and means that a polymer having a polar group is inserted between layers of a graphene-based material, in the present invention.

In the present specification, “composite” is a technique in which materials having different properties are mixed to derive preferred complex physical properties. In the present invention, a graphene-based material having a two-dimensional structure and a carbon nanotube having a one-dimensional structure are composited with a polymer to maintain electrical conductivity even in a state that tension-contraction is repeated.

The present invention for achieving the object relates to a graphene-based liquid crystal dispersion, a liquid crystal composite elastic fiber, and a method of manufacturing the same.

Hereinafter, the present invention will be described in more detail.

A method of manufacturing a liquid crystal composite elastic fiber according to the present invention includes:

a) dispersing or chemically reacting a graphene-based material in or with a polymer solution including a polymer having a polar group to prepare a graphene-based composition in which the polymer having a polar group is intercalated in the graphene-based material; and

b) spinning the graphene-based composition to obtain the liquid crystal composite elastic fiber.

The liquid crystal composite elastic fiber manufactured by the manufacturing method according to the present invention solves the problem of a conventional composite fiber in that when the fiber includes up to 1% by weight of the graphene-based material in a spinning solution, various oxygen functional groups are included and due to occurrence of gelation, the graphene-based material is not included at a high concentration, and thus, the liquid crystal composite elastic fiber manufactured by the manufacturing method according to the present invention may include the graphene-based material at a high concentration, thereby being capable of providing a liquid crystal composite elastic fiber having better electrical conductivity, flexibility, and elasticity.

According to an exemplary embodiment of the present invention, the graphene-based material may have a longest diameter/thickness ratio which is a ratio of the longest diameter to the thickness is 30 or more. Preferably, the longest diameter/thickness ratio may be 10,000 to 500,000. More preferably, the longest diameter/thickness ratio may be 10,000 to 100,000, but is not limited thereto. When a graphene-based material having the longest diameter/thickness ratio is used, the composition may be prepared at a critical concentration for exhibiting crystallinity to exhibit a liquid crystal phase and has excellent dispersibility in a polymer solution, which is preferred.

According to an exemplary embodiment of the present invention, the graphene-based material may be any one or a mixture of two or more selected from the group consisting of reduced graphene (RG), reduced graphene oxide (RGO), graphene, graphene oxide (GO), and the like. As a non-limiting example, the graphene-based material may be preferably graphene oxide (GO) for improving dispersibility and compatibility.

According to an exemplary embodiment of the present invention, the graphene oxide may be used in the sense of graphene oxide, oxidized graphene, and the like. Furthermore, this graphene oxide is not limited when it is prepared by a commonly used preparation method of graphene oxide, however, specifically, may be prepared by a method of oxidizing a carbon material such as graphite. More specifically, the graphene oxide prepared by a method of oxidizing graphite using an oxidization method such as a Hummer's method, a Brodie's method, or a Staudenmaier method, may be used.

According to an exemplary embodiment of the present invention, the graphene-based material may have an oxidization degree of 1:0.1 to 1:2, preferably 1:0.2 to 1:1.5, and more preferably 1:0.2 to 1:1, as an elemental ratio of carbon:oxygen. As described above, when graphene-based composition which is a spinning solution is prepared with the graphene-based material having an elemental ratio of carbon:oxygen, the composition may be maintained at a low viscosity to prevent gelation and a higher content of the graphene-based material may be contained in the spinning solution, which is thus preferred.

According to an exemplary embodiment of the present invention, the polymer having a polar group may be a polymer including a polar group selected from the group consisting of a hydroxyl group (—OH), a carboxyl group (—COOH), an amine group (—NH₂), a sulfonic acid group (—SO₃H), and an isocyanate group (—NCO), and a salt thereof, as a non-limiting example. Preferably, the polymer may be any one or two or more polymers selected from the group consisting of polyalkylene glycol-based polymers, polyurethane-based polymers, and polyvinyl alcohol-based polymers, which may maintain a liquid crystal phase in a state that phase separation between the graphene-based materials in the graphene-based composition does not occur and impart retractility.

As a specific example, the polyalkylene glycol-based polymer may be a polyalkylene glycol-based polymer which is a polyalkylene glycol-based polymer having one or more hydroxyl groups at the terminal and has 1 to 4 carbon atoms in the repeating unit. More specifically, the polyalkylene glycol-based polymer may be any one or a mixture of two or more selected from the group consisting of polyethylene glycol, polypropylene glycol, a polyethylene glycol-polypropylene glycol copolymer, polytetramethylene ether glycol, and the like, but is not limited thereto.

The polyurethane-based polymer is a polymer containing a reactive functional group at the terminal, and for example, may be a polyurethane-based polymer containing an isocyanate group at the terminal. Specifically, when the polyurethane-based polymer is soluble in a solvent in which the graphene-based material is dispersible, the type of the polyurethane-based polymer is not particularly limited.

A solvent in which the graphene-based material is dispersible may be selected from the group consisting of, for example, ether-based solvent, alcohol-based solvents, aromatic solvents, alicyclic solvents, heteroaromatic solvents, heteroalicyclic solvents, alkane-based solvents, ketone-based solvent, halogenated solvents, and the like. Specifically, the solvent may be selected from the group consisting of chloroform, acetone, ethanol, methanol, benzene, toluene, cyclohexane, n-hexane, pyridine, quinoline, ethylene glycol, dimethylformamide, dimethylacetamide, N-methylpyrrolidine, tetrahydrofuran, and the like, but not limited thereto.

As a non-limiting example, the polyurethane-based polymer may be obtained by reacting a compound of any one or two or more selected from the group consisting of polyether-based polyol, polyester-based polyol, polycarbonate-based polyol, and the like and organic diisocyanate. Specifically, polyether-based polyol may be polyalkylene glycol and the like, and for example, may be a polyalkylene glycol-based polymer having 1 to 4 carbon atoms in the repeating unit. More specifically, the polyether-based polyol may be any one or a mixture of two or more selected from the group consisting of polyethylene glycol, polypropylene glycol, a polyethylene glycol-polypropylene glycol copolymer, polytetramethylene ether glycol, and the like. The polyester-based polyol may be any one or a mixture of two or more selected from the group consisting of polyethylene adipate diol, polybutylene adipate diol, poly(1,6-hexaadipate) diol, polydiethylene adipate diol, poly(e-caprolactone) diol, and the like. The polycarbonate polyol may be any one or a mixture of two or more selected from the group consisting of polyhexamethylene carbonate ol, polyethylene carbonate diol, polypropylene carbonate diol, polybutylene carbonate diol, and the like. The polyurethane-based polymer may be obtained by extending chains by a chain extender having two active hydrogens if necessary, and furthermore, may be a modified polyurethane-based polymer copolymerized with a monomer such as fluorine, amino acid, and silicon, or a mixture with these polymers, but is not limited thereto.

The polyvinyl alcohol-based polymer may be any one or a mixture thereof selected from the group consisting of polyvinyl alcohol, a polyvinylacetate-vinyl alcohol copolymer, a polyethylene-vinyl alcohol copolymer, a polyvinyl alcohol-(meth)acryl copolymer, a polyvinyl alcohol-vinyl chloride copolymer, a polyvinyl alcohol-styrene copolymer, and the like, but is not limited thereto.

The polymer having a polar group according to an exemplary embodiment of the present invention may impart flowability to the graphene-based composition which is the spinning solution containing the graphene-based material at a high concentration. In addition, the graphene-based material contains various oxygen functional groups which are intercalated between graphene-based material layers, and the oxygen functional groups are chemically and physically bonded to the polymer having a polar group, whereby gelation between the graphene-based materials may be prevented.

According to an exemplary embodiment of the present invention, the polymer having a polar group which has a strong attraction to a polar group present on the graphene-based material and may be hydrogen-bonded thereto, may be any one or two or more polymers selected from the group consisting of polyalkylene glycol-based polymers having 1 to 4 hydroxyl groups at the terminal; and polyvinyl alcohol-based polymers including a polyvinyl alcohol homopolymer or a copolymer including 50 mol % or more or a polyvinyl alcohol repeating unit; and the like, or polyurethane-based polymers which may be chemically bonded to a polar group present on the graphene-based material.

According to an exemplary embodiment of the present invention, a network structure in which the polymer having a polar group is intercalated between the graphene-based material layers is formed to improve spinnability and flowability of the graphene-based composition, and manufacture of a fiber by spinning may be facilitated.

In addition, when a fiber is manufactured using the polyurethane-based polymer in the present invention, elasticity may be further imparted to the fiber, and the fiber may be used as a fiber which may be manufactured into a wearable element and the like, which is thus, more preferred.

According to an exemplary embodiment of the present invention, when the polyurethane-based polymer containing a reactive functional group is included as the polymer having a polar group in step a), a step of forming a covalent bond of the polyurethane-based polymer with the graphene-based material may be further included. Specifically, for example, a covalent bond is formed by a chemical bond between an isocyanate group at the terminal of the polyurethane-based polymer and the hydroxyl group or carboxyl group of the graphene-based material, so that the polyurethane polymer is intercalated between the graphene-based material layers and is fixed by a strong bond, thereby maintaining a liquid crystal phase in the state that phase separation does not occur, and aggregation between the graphene-based materials is inhibited to prevent phase behavior of gelation, which may be thus preferred.

According to an exemplary embodiment of the present invention, the graphene-based composition may have liquid crystallinity.

The liquid crystal composite elastic fiber manufactured by spinning the graphene-based composition having liquid crystallinity as described above may have both advantages of the graphene-based material and the liquid crystal, and thus, the directionality thereof may be adjusted using an outer field such as a magnetic field or a flow field which is a unique characteristic of a liquid crystal, optical, dielectric, mechanical properties, and the like which are macroscopically anisotropic may be exhibited to widen the utilization of the graphene-based material, and a new process may be established.

According to an exemplary embodiment of the present invention, 0.8 to 10% by weight, preferably 1 to 8% by weight, and more preferably 1.5 to 8% by weight of the graphene-based material may be included, based on the total weight of the graphene-based composition. When the graphene-based material is included as described above, the graphene-based material is uniformly dispersed in the spinning solution and a lyotropic liquid crystal phase is produced, whereby liquid crystallinity may be imparted and better electrical conductivity may be expressed, which is thus preferred.

In addition, when containing up to 1% by weight of the graphene-based material, the conventional spinning solution including the graphene-based material caused gelation to limit the flowability due to a high viscosity, and thus, when the graphene-based composition including the graphene-based material at a low concentration in the spinning solution was manufactured into a fiber, there was a limitation in reduction of process costs and improvement of electrical conductivity. However, the spinning solution according to the present invention does not cause gelation by the polymer having a polar group intercalated between the graphene-based material layers even in the case that the graphene-based material includes the graphene-based material at a high concentration of 1% by weight or more, may secure a fiber having high orientation, and may secure excellent flowability and spinnability due to further decreased viscosity of the graphene-based composition.

In addition, when the graphene-based composition has liquid crystallinity, the higher the content of the polymer having a polar group, the better the liquid crystallinity.

The graphene-based composition according to the present invention may exhibit a viscosity satisfying the following Equation 1 even when the content of the graphene-based material is a high concentration of 1% by weight or more, and thus, may secure flowability of the spinning solution for manufacturing a fiber:

$$0.05 ≺ \frac{{η}_{2}}{{η}_{1}} ≺ 0.7 \qquad [ Equation 1 ]$$

wherein η₁ is a viscosity of a dispersion in which only the graphene-based material and the solvent are mixed and dispersed, and η₂ is a viscosity of a dispersion in which the graphene-based material and the polymer solution are mixed and dispersed.

Preferably, for securing the flowability and the spinnability of the graphene-based composition, the viscosity of Equation 1 may satisfy 0.1 to 0.7.

According to an exemplary embodiment of the present invention, the graphene-based material may be uniformly and stably dispersed in the polymer solution by a ultrasonic processing method, a mechanical stirring method, a mixed method thereof, and the like for uniformly dispersing the graphene-based material in the polymer solution, but not limited thereto. In addition, according to an exemplary embodiment, impurities contained in the graphene-based composition in which the graphene-based material is dispersed in the polymer solution may be removed using dialysis or centrifugation, but not limited thereto.

According to an exemplary embodiment of the present invention, the polymer solution may include 1 to 40% by weight and more preferably 5 to 25% by weight of the polymer having a polar group, based on the total weight of the polymer solution. When the polymer solution is prepared within the above range, the polymer may be sufficiently intercalated between the graphene-based material layers, and the graphene-based material is dispersed to inhibit direct contact between the graphene-based materials, thereby preventing gelation occurring by a rapid increase of viscosity to improve spinnability of the spinning solution. In addition, the liquid crystal composite elastic fiber manufactured therefrom has excellent toughness, flexibility, and mechanical strength.

According to an exemplary embodiment of the present invention, the polymer solution may be prepared by including the polymer having a polar group and a solvent. In the solvent, the graphene-based material is dispersed and also the polymer having a polar group is dissolved to be dispersed. For example, the solvent may be selected from the group consisting of water, alcohol-based solvent, ether-based solvent, amide-based solvent, and the like. Specifically, the solvent may be selected from the group consisting of water, ethylene glycol, dimethylformide, dimethylacetamide, N-methylpyrrolidone, tetrahydrofuran, and the like, but not limited thereto.

According to an exemplary embodiment of the present invention, the graphene-based material of the graphene-based composition and the polymer having a polar group may be bonded at a weight ratio of 1:0.1 to 1:1,000, preferably 1:0.1 to 1:500, more preferably 1:0.1 to 1:100, and more preferably 1:0.1 to 1:10, but not limited thereto. By the bonding, the flowability and spinnability of the graphene-based composition may be improved by a viscosity decrease, which may be thus preferred. In addition, the graphene-based composition may exhibit a liquid crystal phase in a state that phase separation between the graphene-based material and the polymer having a polar group in the graphene-based composition does not occur.

According to an exemplary embodiment, the graphene-based composition may further include a carbon nanotube. When the carbon nanotube is further included, higher toughness than cobwebs may be exhibited. The fiber having such excellent toughness may be used as a fiber which may be manufactured into a wearable element and the like since the carbon nanotube (CNT) is aligned in a fiber direction with the excellent toughness to maximize an interaction between the carbon nanotube and the polymer, and thus, is more preferred.

According to an exemplary embodiment of the present invention, the carbon nanotube may be specifically, for example, any one or a mixture of two or more selected from the group consisting of a single-walled carbon nanotube, a few-walled carbon nanotube, a multi-walled carbon nanotube, or a combination thereof, but not limited thereto. The carbon nanotube may be classified into a single-walled carbon nanotube (SWCNT), a few-walled carbon nanotube (FWCNT) having 2 to 10 carbon walls, a multi-walled carbon nanotube (MWCNT) having 10 or more multiple layers of carbon nanotubes forming a concentric circle, and the like, depending on the structure, but not limited thereto.

According to an exemplary embodiment of the present invention, the graphene-based material and the carbon nanotube may be composited and used in the graphene-based composition and a weight ratio of the graphene-based material and the carbon nanotube may be 1:0.1 to 1:1, and more preferably 1:0.1 to 1:0.5. When the graphene-based material and the carbon nanotube composited at the weight ratio is used, an effect of increasing the mechanical properties of the liquid crystal composite elastic fiber to be manufactured may be obtained, and the composite has excellent toughness and flexibility to be manufactured into various forms of fibers, or may be deformed into various forms to be applied to materials.

According to an exemplary embodiment of the present invention, the spinning may be wet spinning or electrospinning.

The wet spinning is a method in which pressure is applied to the graphene-based composition to perform spinning into a coagulation bath in which the fiber is coagulated through a small spinneret so that the fiber is allowed to be coagulated in the coagulation bath, and thus, the solvent is solidified by diffusion of the solvent into the coagulation bath and leached, thereby forming the fiber. The wet spinning may cause a chemical reaction in the spinning solution, and be used when the polymer is not dissolved or easily melted in an easily evaporable solvent. The liquid crystal composite elastic fiber may have mechanical physical properties so that the liquid crystal composite elastic fiber is sufficiently wound on a roller.

According to an exemplary embodiment of the present invention, a spinning temperature of the spinning solution may be 10 to 100° C., and preferably 20 to 80° C., but not limited thereto. In addition, a pressure at the time of spinning the spinning solution may be in a range of 1 to 50 psi, is but not limited thereto. The temperature of the coagulation solution may be −5 to 50° C., and preferably 0 to 40° C. for solidification of the fiber to be spun, but is not limited thereto. In addition, as the coagulation solution, any one or a mixture of two or more selected from the group consisting of an aqueous calcium chloride (CaCl₂) solution, N-methylpyrrolidone, formamide water, methanol, ethanol, propanol methyl sulfoxide, dimethyl formamide, dimethylacetamide, ethyl acetate, acetone, and the like may be used, the coagulation solution is not dissolved in the polymer having a polar group in the spinning solution, and it is preferred to use a non-solvent having excellent compatibility with the solvent of the polymer solution. Accordingly, it may be preferred to use the different types of coagulation solution and solvent of the polymer solution.

According to an exemplary embodiment of the present invention, as a specific example, a fiber structure in which the solvent is evaporated by a positive (+) voltage and simultaneously, the polymer material is intercalated between the graphene-based material layers may be manufactured by the electrospinning. The electrospun fiber is collected by a collector having a relatively negative (−) charge by an electric field. The positive (+) voltage and the negative (−) voltage at the time of electrospinning may be appropriately selected depending on the polymer material and the solvent. In addition, the thickness may be adjusted and the quality of the fiber to be manufactured may be determined by an applied voltage per a distance at the time of electrospinning (kV/cm), a solution injection amount (mL/min, mL/h, l/h), and a nozzle (needle). The positive (+) applied voltage at the time of electrospinning is adjusted by a distance between the collector and the nozzle together with the unique characteristics of the polymer material, and for example, though it is not particularly limited, the applied voltage may be 6 to 50 kV, and more preferably 6 to 15 kV, and the distance between the nozzle and the collector may be 8 to 30 cm, and preferably 10 to 15 cm and the collector may be a conductor such as an aluminum foil. In the case of the solution injection amount, when the solution is rapidly injected, a higher positive (+) applied voltage is needed, and it is possible to adjust a manufacture amount depending a time. In addition, a diameter of the nozzle is generally various ranging from 0.1 to 1.4 mm, but the nozzle for electrospinning may be determined depending on the polymer material and the uniformity and the thickness of the fiber to be manufactured may be determined depending on the selection of the nozzle.

The liquid crystal composite elastic fiber manufactured by spinning according to an exemplary embodiment of the present invention may undergo a predetermined drying process after washing for completely removing the solvent remaining in the solid content. The drying is not particularly limited and may be performed by a commonly used drying means, but is not limited thereto.

Hereinafter, the liquid crystal composite elastic fiber according to the present invention will be described in more detail.

The liquid crystal composite elastic fiber according to the present invention may be a fiber in which a polymer having a polar group is inserted between the graphene-based material layers and hydrogen-bonded or covalently bonded to the graphene-based material. When the polymer having a polar group is inserted between the graphene-based material layers and hydrogen-bonded or covalently bonded to the graphene-based material, the conventional problem that gelation occurs in the case of including up to 1% by weight of the graphene-based material in the spinning solution, so that the graphene-based material is not able to be included at a high concentration, is solved, and thus, the graphene-based material may be included at a high concentration of 1% by weight or more. Thus, the liquid crystal composite elastic fiber having better electrical conductivity, flexibility, orientation, and elasticity may be provided.

In addition, when the graphene-based composition has liquid crystallinity, the composition may be spun into a fiber in a state of maintaining a liquid crystal phase, and may maintain the liquid crystal phase even after the spinning. Accordingly, the liquid crystal composite elastic fiber manufactured by spinning the graphene-based composition has excellent orientation in the fiber axial direction and may have significantly improved modulus of elasticity, thermal conductivity, and electrical conductivity in the axial direction even with a small amount of the graphene-based material.

According to an exemplary embodiment of the present invention, the graphene-based material and the polymer having a polar group may be bonded at a weight ratio of 1:0.1 to 1:40. When the graphene-based material and the polymer are bonded as described above, electrical conductivity is improved, and liquid crystallinity, orientation, and toughness are improved, thereby manufacturing a fiber having excellent elasticity, which is thus preferred.

According to an exemplary embodiment, the graphene-based material may be composited with a carbon nanotube. According to an exemplary embodiment of the present invention, the graphene-based material and the carbon nanotube may be composited at a weight ratio of 1:0.1 to 1:1. When the carbon nanotube is composited with the graphene-based material as described above, higher toughness than cobwebs may be exhibited and contact points between conductive materials may be increased, thereby further improving electrical conductivity, which is thus preferred. In addition, the fiber may be used as a fiber which may be manufactured into a wearable element and the like having improved electrical conductivity and toughness by an interaction with the polymer having a polar group, which is thus more preferred.

The liquid crystal composite elastic fiber according to the present invention may have both advantages of the graphene-based material and the liquid crystal, and thus, the directionality thereof may be adjusted using an outer field such as a magnetic field or a flow field which is a unique characteristic of a liquid crystal, optical, dielectric, mechanical properties, and the like, which are macroscopically anisotropic, may be exhibited to widen the utilization of the graphene-based material, and a new process may be established.

In the present invention, when the graphene-based composition has liquid crystallinity, the composition may be used in the same sense of the following graphene-based liquid crystal dispersion, and will be described in more detail as follows.

In the graphene-based liquid crystal dispersion according to the present invention, the polymer in the polymer solution including the polymer having a polar group is dispersed in or chemically reacted with the graphene-based material so that the polymer is intercalated in the graphene-based material, whereby the graphene-based material and the polymer having a polar group are hydrogen-bonded or covalently bonded, and the dispersion may have a viscosity satisfying the following Equation 1:

$$0.05 ≺ \frac{{η}_{2}}{{η}_{1}} ≺ 0.7 \qquad [ Equation 1 ]$$

wherein η₁ is a viscosity of a dispersion in which only the graphene-based material and the solvent are mixed and dispersed, and η₂ is a viscosity of a dispersion in which the graphene-based material and the polymer solution are mixed and dispersed.

Preferably, for securing the flowability and the spinnability of the graphene-based crystal dispersion, the viscosity of Equation 1 may satisfy 0.1 to 0.7.

The graphene-based liquid crystal dispersion described above may have excellent spinnability and flowability even in the case of including the graphene-based material at a high concentration, and when the liquid crystal composite elastic fiber is manufactured by spinning the dispersion, the fiber may have excellent electrical conductivity, toughness, elasticity, and liquid crystallinity, which is thus preferred.

Hereinafter, a graphene-based liquid crystal dispersion, a liquid crystal composite elastic fiber, and a method of manufacturing the same according to the present invention will be described in more detail by the following Examples. However, the following Examples are only a reference for describing the present invention in detail, and the present invention is not limited thereto, and may be implemented in various forms.

In addition, unless otherwise defined, all technical terms and scientific terms have the same meanings as those commonly understood by one of those skilled in the art to which the present invention pertains. The terms used herein is only for effectively describing a certain exemplary embodiment, and not intended to limit the present invention.

Further, unless otherwise stated, the unit of added materials herein may be % by weight.

### PREPARATION EXAMPLE 1

To 100 g of a 10% by weight aqueous solution of polyethylene glycol having two hydroxyl groups at the terminal (a weight average molecular weight of 400-200,000 g/mol), 1.5 g of a graphene oxide (standard graphene prepared by a Co. Hummer's method) was added and the solution was stirred at 45° C. for a day to prepare a graphene-based composition. The viscosity of the thus-prepared graphene-based composition was 8 Pa·s as measured at 25° C. with a rotational viscometer (Brookfield DV-II).

### PREPARATION EXAMPLE 2

A graphene-based composition was prepared in the same manner as in Preparation Example 1, except that a solution of polyurethane having one isocyanate group at the terminal (Lankaster Co., UK) dissolved at 10% by weight in dimethyl formamide was used instead of the 10% by weight aqueous polyethylene glycol solution. The viscosity of the thus-prepared graphene-based composition was 10 Pa·s as measured at 25° C. with a rotational viscometer (Brookfield DV-II).

### PREPARATION EXAMPLE 3

A graphene-based composition was prepared in the same manner as in Preparation Example 1, except that a 10% by weight aqueous polyvinyl alcohol (400-200,000 g/mol, Sigma-Aldrich) solution was used instead of the 10% by weight aqueous polyethylene glycol solution. The viscosity of the thus-prepared graphene-based composition was 10 Pa·s as measured at 25° C. with a rotational viscometer (Brookfield DV-II).

### PREPARATION EXAMPLE 4

A graphene-based composition was prepared in the same manner as in Preparation Example 2, except that 0.6 g of graphene oxide (standard graphene, manufactured by a Co. Hummer's method) was used. The viscosity of the thus-prepared graphene-based composition was 5 Pa·s as measured at 25° C. with a rotational viscometer (Brookfield DV-II).

### PREPARATION EXAMPLE 5

A graphene-based composition was prepared in the same manner as in Preparation Example 2, except that 0.1 g of graphene oxide (standard graphene, manufactured by a Co. Hummer's method) was used. The viscosity of the thus-prepared graphene-based composition was 15 Pa·s as measured at 25° C. with a rotational viscometer (Brookfield DV-II).

### PREPARATION EXAMPLE 6

A graphene-based composition was prepared in the same manner as in Preparation Example 2, except that 3 g of graphene oxide (standard graphene, manufactured by a Co. Hummer's method) was used. The viscosity of the thus-prepared graphene-based composition was 15 Pa·s as measured at 25° C. with a rotational viscometer (Brookfield DV-II).

### PREPARATION EXAMPLE 7

A graphene-based composition was prepared in the same manner as in Preparation Example 2, except that a polyurethane solution dissolved at 20% by weight in dimethyl formamide instead of the polyurethane solution dissolved at 10% by weight in dimethyl formamide. The viscosity of the thus-prepared graphene-based composition was 3 Pa·s as measured at 25° C. with a rotational viscometer (Brookfield DV-II).

### PREPARATION EXAMPLE 8

A graphene-based composition was prepared in the same manner as in Preparation Example 2, except that a polyurethane solution dissolved at 1% by weight in dimethyl formamide instead of the polyurethane solution dissolved at 10% by weight in 5dimethyl formamide. The viscosity of the thus-prepared graphene-based composition was 30 Pa·s as measured at 25° C. with a rotational viscometer (Brookfield DV-II).

### PREPARATION EXAMPLE 9

A graphene-based composition was prepared in the same manner as in Preparation Example 1 except that 0.75 g of a single-walled carbon nanotube was further included in the graphene-based composition. The viscosity of the thus-prepared graphene-based composition was 8 Pa·s as measured at 25° C. with a rotational viscometer (Brookfield DV-II).

### COMPARATIVE PREPARATION EXAMPLE 1

A graphene-based composition in which 1.5 g of graphene oxide was dispersed in 100 ml of distilled water was prepared. The viscosity of the thus-prepared graphene-based composition was 45 Pa·s as measured at 25° C. with a rotational viscometer (Brookfield DV-II).

### COMPARATIVE PREPARATION EXAMPLE 2

A graphene-based composition was prepared in the same manner as in Preparation Example 1, except that a solution in which 10% by weight of polymethyl methacrylate was dissolved in chloroform was used instead of the 10% by weight aqueous polyethylene glycol solution. The viscosity of the thus-prepared graphene-based composition was 38 Pa·s as measured at 25° C. with a rotational viscometer (Brookfield DV-II).

### COMPARATIVE PREPARATION EXAMPLE 3

A graphene-based composition was prepared in the same manner as in Preparation Example 1, except that a 10% by weight aqueous polyacrylic acid solution was used instead of the 10% by weight aqueous polyethylene glycol solution. The viscosity of the thus-prepared graphene-based composition was 28 Pa·s as measured at 25° C. with a rotational viscometer (Brookfield DV-II).

### COMPARATIVE PREPARATION EXAMPLE 4

A graphene-based composition was prepared in the same manner as in Preparation Example 2, except that a solution in which 10% by weight of polystyrene was dissolved in dimethyl formamide was used instead of the 10% by weight polyurethane solution. The viscosity of the thus-prepared graphene-based composition was 41 Pa·s as measured at 25° C. with a rotational viscometer (Brookfield DV-II).

### COMPARATIVE PREPARATION EXAMPLE 5

A graphene-based composition was prepared in the same manner as in Preparation Example 1, except that a solution in which 10% by weight of polyethylene was dissolved in toluene was used instead of the 10% by weight aqueous polyethylene glycol solution. The viscosity of the thus-prepared graphene-based composition was 36 Pa·s as measured at 25° C. with a rotational viscometer (Brookfield DV-II).

### COMPARATIVE PREPARATION EXAMPLE 6

A graphene-based composition was prepared in the same manner as in Preparation Example 1, except that a solution in which 10% by weight of polythiophene was dissolved in chloroform was used instead of the 10% by weight aqueous polyethylene glycol solution. The viscosity of the thus-prepared graphene-based composition was 47 Pa·s as measured at 25° C. with a rotational viscometer (Brookfield DV-II).

### EXAMPLE 1

The graphene-based composition prepared in Preparation Example 1 was wet-spun at 25° C. using a spinning nozzle having a spinning nozzle diameter of 250 μm. Spinning was performed into a coagulation solution at 25° C. which is a mixed solution of an aqueous solution of water and methanol at a weight ratio of 3:1 and calcium chloride (CaCl₂) at a discharge speed of 0.1 m/min, and winding was performed at 0.1 m/min. A wound yarn was washed to remove remaining calcium chloride and then dried, and the temperature was adjusted to 70° C. with an infrared lamp to perform thermal drawing 1.3 times.

### EXAMPLE 2

The graphene-based composition prepared in Preparation Example 1 was supplied to a spinning solution feeder connected to a nozzle. The graphene-based composition was supplied at a supply speed of 4 ml/hr, the used inner diameter size of the nozzle was 0.5 mm, and electrospinning was carried out under the spinning conditions of an applied voltage of 25 kV, a spinning distance between the spinning nozzle and a current collector of 18 cm, a temperature of 30° C., and a relative humidity of 60%.

### EXAMPLE 3

The graphene-based composition prepared in Preparation Example 2 was wet-spun at 25° C. using a spinning nozzle having a spinning nozzle diameter of 250 μm. Spinning was performed into a mixed coagulation solution at 25° C. of dimethyl formamide, ethyl acetate, and acetone at a weight ratio of 1:1:1 at a discharge speed of 0.1 m/min and winding was performed at 0.1 m/min. A wound yarn was washed to remove remaining coagulation solution and then dried, and the temperature was adjusted to 70° C. with an infrared lamp to perform thermal drawing 1.3 times.

### EXAMPLE 4

The process was carried out in the same manner as in Example 1, except that the graphene-based composition prepared in Preparation Example 3 was used.

### EXAMPLE 5

The process was carried out in the same manner as in Example 1, except that the graphene-based composition prepared in Preparation Example 4 was used.

### EXAMPLE 6

The process was carried out in the same manner as in Example 1, except that the graphene-based composition prepared in Preparation Example 5 was used.

### EXAMPLE 7

The process was carried out in the same manner as in Example 1, except that the graphene-based composition prepared in Preparation Example 6 was used.

### EXAMPLE 8

The process was carried out in the same manner as in Example 3, except that the graphene-based composition prepared in Preparation Example 7 was used.

### EXAMPLE 9

The process was carried out in the same manner as in Example 3, except that the graphene-based composition prepared in Preparation Example 8 was used.

### EXAMPLE 10

The process was carried out in the same manner as in Example 1, except that the graphene-based composition prepared in Preparation Example 9 was used.

### COMPARATIVE EXAMPLE 1

The process was carried out in the same manner as in Example 1, except that the graphene-based composition prepared in Comparative Preparation Example 1 was used. Gelation occurred in the solution of Comparative Preparation Example 1, so that spinning was impossible.

### COMPARATIVE EXAMPLE 2

The process was carried out in the same manner as in Example 1, except that the graphene-based composition prepared in Comparative Preparation Example 2 was used.

### COMPARATIVE EXAMPLE 3

The process was carried out in the same manner as in Example 1, except that the graphene-based composition prepared in Comparative Preparation Example 3 was used.

### COMPARATIVE EXAMPLE 4

The process was carried out in the same manner as in Example 3, except that the graphene-based composition prepared in Comparative Preparation Example 4 was used.

### COMPARATIVE EXAMPLE 5

The process was carried out in the same manner as in Example 1, except that the graphene-based composition prepared in Comparative Preparation Example 5 was used and a mixed solution of ethyl acetate and acetone at a weight ratio of 1:1 was used as the coagulation solution.

### COMPARATIVE EXAMPLE 6

The process was carried out in the same manner as in Example 1, except that the graphene-based composition prepared in Comparative Preparation Example 6 was used and a mixed solution of ethyl acetate and acetone at a weight ratio of 1:1 was used as the coagulation solution.

### EXPERIMENTAL EXAMPLE 1

### Measurement of Liquid Crystallinity of Graphene-Based Composition

As shown in FIG. 3, the liquid crystallinity was measured by adjusting the concentration of the solution to 0.2 to 1% by weight, placing the sample between polarizing plates in a polarizing microscope, and observing the sample to observe orientation. In addition, it was confirmed that as the concentration was increased, a full nematic phase was more observed.

### EXPERIMENTAL EXAMPLE 2

1. Measurement of Electrical Conductivity of Liquid Crystal Composite Elastic Fiber

The electrical conductivity of the liquid crystal composite elastic fibers of Examples 1 to 8 and Comparative Examples 1 and 2 was measured by a 4-point probe measurement method, using CMT-SR1000N manufactured by AIT, Co., Ltd.

2. Toughness Strength

Strength and elongation were measured under the conditions of a sample length of 250 mm, a tensile speed of 300 mm/min, and 80 turns/m, under a standard state (20° C., a relative humidity of 65%), in accordance with the ASTM D 885 standard, using 5565 (manufactured by Instron Corporation, U.S.A).

Toughness strength(toughness)(g/d)=Strength(g/d)×\sqrt{Breakage}(%)

3. Elasticity (Modulus of Elasticity)

The tensile modulus (modulus of elasticity) was determined from an initial slope of a strain-stress curve obtained in the tensile experiment.

4. Spinnability

Spinnability was evaluated under the following criteria of judgement.

◯: No trouble such as fiber breaks, windable.

Δ: Occasional fiber breaks, but windable at a specified winding speed.

×: Not windable at a specified winding speed.

Fibers having excellent spinnability to have excellent physical properties even when manufactured by wet spinning or electrospinning were manufactured in Examples 1 to 10, and the liquid crystal composite elastic fibers manufactured above were confirmed to have excellent electrical conductivity, toughness strength and elasticity.

In addition, since in the liquid crystal composite elastic fiber manufactured in the Example of the present invention, the polymer having a polar group is intercalated in or chemically reacted to be dispersed in the graphene-based material layers and a hydrogen bond or a covalent bond was derived, and thus, a spinning solution having no phase separation was able to be manufactured. In addition, even when the graphene-based material was included at 0.8% by weight or more in the graphene-based composition, it was confirmed that the viscosity was decreased as compared with Comparative Example 1, thereby manufacturing a fiber having excellent spinnability.

In particular, when the polymer having a polar group according to the present invention is polyurethane, it was confirmed that a liquid crystal composite elastic fiber having better electrical conductivity, toughness strength, and elasticity was manufactured.

In addition, when a carbon nanotube was further included in the graphene-based composition according to the present invention to manufacture the fiber, it was confirmed that the tensile strength was significantly improved.

In addition, it was confirmed that in the Comparative Example using the polymer other than the polymer having a polar group of the present invention, the viscosity was maintained or slightly decreased. In addition, it was confirmed that the Comparative Example thus had very low electrical conductivity, toughness strength, and elasticity.

Hereinabove, although the graphene-based liquid crystal dispersion, a liquid crystal composite elastic fiber, and a method of manufacturing the same have been described in the present invention by specific matters and limited exemplary embodiments, the exemplary embodiments have been provided only for assisting in the entire understanding of the present invention, and the present invention is not limited to the above exemplary embodiments. Various modifications and changes may be made by those skilled in the art to which the present invention pertains from this description.

Therefore, the spirit of the present invention should not be limited to the above-described exemplary embodiments, and the following claims as well as all modified equally or equivalently to the claims are intended to fall within the scope and spirit of the invention.

1. A method of manufacturing a liquid crystal composite elastic fiber, the method comprising:
a) dispersing or chemically reacting a graphene-based material in or with a polymer solution including a polymer having a polar group to prepare a graphene-based composition in which the polymer having a polar group is intercalated in the graphene-based material; and
b) spinning the graphene-based composition to obtain the liquid crystal composite elastic fiber.

2. The method of manufacturing a liquid crystal composite elastic fiber of claim 1, wherein the graphene-based composition has liquid crystallinity.

3. The method of manufacturing a liquid crystal composite elastic fiber of claim 1, wherein the graphene-based composition further includes a carbon nanotube.

4. The method of manufacturing a liquid crystal composite elastic fiber of claim 3, wherein a weight ratio of the graphene-based material and the carbon nanotube is 1:0.1 to 1:1.

5. The method of manufacturing a liquid crystal composite elastic fiber of claim 1, wherein 0.8 to 10% by weight of the graphene-based material is included, based on the total weight of the graphene-based composition.

6. The method of manufacturing a liquid crystal composite elastic fiber of claim 1, wherein the polymer solution includes 1 to 40% by weight of the polymer having a polar group, based on the total weight of the polymer solution.

7. The method of manufacturing a liquid crystal composite elastic fiber of claim 1, wherein the spinning is wet spinning or electrospinning.

8. The method of manufacturing a liquid crystal composite elastic fiber of claim 1, wherein the polymer having a polar group is any one or two or more polymers selected from the group consisting of polyalkylene glycol-based polymers, polyurethane-based polymers, and polyvinyl alcohol-based polymers.

9. The method of manufacturing a liquid crystal composite elastic fiber of claim 8, further comprising: forming a covalent bond of the polyurethane-based polymer including a reactive functional group in a) with the graphene-based material.

10. (canceled)

11. A liquid crystal composite elastic fiber, wherein a polymer having a polar group is inserted between graphene-based material layers to be hydrogen-bonded or covalently bonded to a graphene-based material.

12. The liquid crystal composite elastic fiber of claim 11, wherein the graphene-based material further includes a carbon nanotube and is composited.

13. The liquid crystal composite elastic fiber of claim 11, wherein the graphene-based material and the carbon to the nanotube are composited a weight ratio of 1:0.1 to 1:1.

14. The liquid crystal composite elastic fiber of claim 11, wherein the graphene-based material and the polymer having a polar group are bonded at a weight ratio of 1:0.1 to 1:1,000.

15. A graphene-based liquid crystal dispersion, wherein a graphene-based material and a polymer having a polar group are hydrogen-bonded or covalently bonded and intercalated, and the dispersion has a viscosity satisfying the following Equation 1:
$$0.05 ≺ \frac{{η}_{2}}{{η}_{1}} ≺ 0.7 \qquad [ Equation 1 ]$$
wherein η₁ is a viscosity of a dispersion in which only a graphene-based material and a solvent are mixed and dispersed, and η₂ is a viscosity of a dispersion in which the graphene-based material and a polymer solution are mixed and dispersed.
